(19) United States
(12) Patent Application Publication
(10) Pub. No.: US 2009/0290261 A1
(43) Pub. Date: Nov. 26, 2009

(54) CARRIAGE ASSEMBLY AND DISK DRIVE

(75) Inventors: Hisashi Kaneko, Kawasaki (JP); Keiji Aruga, Machida (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/358,094

(22) Filed: Jan. 22, 2009

(30) Foreign Application Priority Data
May 22, 2008 (JP) 2008-134367

(51) Int. Cl. G11B 21/16

(52) U.S. Cl. 360/245.8; G9B/21.023

(57) ABSTRACT

A carriage block body is coupled to a support shaft for relative rotation. A carriage arm extends from the carriage block body along an imaginary plane perpendicular to the longitudinal axis of the support shaft. A head suspension is attached to the tip end of the carriage arm. A wiring extends outside the contour of the head suspension along the side of the carriage arm. A projection protrudes from the side of the carriage arm. An adhesive is utilized to bond the wiring to the projection. Even though airflow generated along the surface of a rotating disk medium collides against the carriage arm, the wiring is reliably prevented from fluttering outside the contour of the head suspension. The vibration of the wiring is thus significantly suppressed. The carriage arm is prevented from vibrating.

### CROSS-REFERENCE TO RELATED APPLICATION

This application is based upon and claims the benefit of priority from the prior Japanese Patent Application No. 2008-134367 filed on May 22, 2008, the entire contents of which are incorporated herein by reference.

### FIELD

The embodiments discussed herein are related to a carriage assembly preferably incorporated in a disk drive such as a hard disk drive, HDD.

### BACKGROUND

In a hard disk drive, a head suspension is attached to the front or tip end of a carriage arm. A flexure is bonded to the head suspension. A flying head slider is fixed on the flexure. The flexure extends backward outside the contour of the head suspension along the side of the carriage arm. The flexure is connected to a head IC (integrated circuit) on a carriage block. The flexure thus serves as a wiring connecting the flying head slider to the head IC.

The swinging movement of the carriage arm allows the flying head slider to face the surface of a magnetic recording disk at a distance. When the magnetic recording disk rotates, the flying head slider is allowed to receive airflow generated along the rotating magnetic recording disk. In this manner, the flying head slider is allowed to fly above the surface of the magnetic recording disk. The airflow causes the flexure to flutter outside the contour of the carriage arm, for example. The flutter induces the resonance of the carriage arm. This results in a deterioration of the accuracy in the positioning of the flying head slider.

### SUMMARY

According to an aspect of the present invention, there is provided a carriage assembly including: a carriage block body coupled to a support shaft for relative rotation; a carriage arm extending from the carriage block body along an imaginary plane perpendicular to the longitudinal axis of the support shaft; a head suspension attached to the tip end of the carriage arm; a wiring attached to the surface of the head suspension, the wiring extending backward outside the contour of the head suspension along the side of the carriage arm; a projection protruding from the side of the carriage arm, the projection receiving the wiring; and an adhesive utilized to bond the wiring to the projection.

The carriage assembly allows the wiring to extend outside the contour of the head suspension. The wiring is received on the projection at a position outside the contour of the head suspension. The adhesive is utilized to bond the wiring to the projection. Accordingly, even though airflow generated along the surface of a rotating disk medium collides against the carriage arm, the wiring is reliably prevented from fluttering outside the contour of the head suspension. The vibration of the wiring is thus significantly suppressed. The carriage arm is prevented from vibrating. The carriage assembly may be incorporated in a disk drive.

The objects and advantages of the invention will be realized and attained by means of the elements and combinations particularly pointed out in the claims. It is to be understood that both the foregoing general description and the following detailed description are exemplary and explanatory only and are not restrictive of the invention, as claimed.

### BRIEF DESCRIPTION OF THE DRAWINGS

FIG. 1 is a plan view schematically illustrating the inner structure of a hard disk drive, HDD, as a specific example of a disk drive according to the present invention;

FIG. 2 is a plan view schematically illustrating a head suspension assembly according to a specific example;

FIG. 3 is a perspective view schematically illustrating a carriage assembly according to a first embodiment of the present invention;

FIG. 4 is a side view schematically illustrating the carriage assembly;

FIG. 5 is a graph presenting a frequency spectrum per frequency;

FIG. 6 is a plan view illustrating the process of forming a groove in the carriage arm based on scraping;

FIG. 7 is a side view illustrating the process of attaching the head suspension assembly to the carriage arm;

FIG. 8 is a perspective view schematically illustrating a carriage assembly according to a second embodiment of the present invention; and

FIG. 9 is an enlarged partial sectional view schematically illustrating the carriage assembly.

### DESCRIPTION OF EMBODIMENTS

Preferred embodiments of the invention will be explained below with reference to the accompanying drawings.

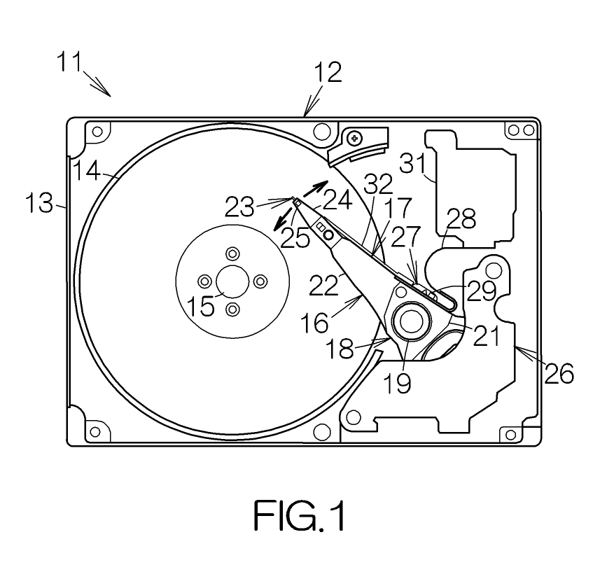

FIG. 1 schematically illustrates the inner structure of a hard disk drive, HDD, 11 as an example of a disk drive according to the present invention. The hard disk drive 11 includes an enclosure 12 including a box-shaped base 13 and an enclosure cover, not illustrated. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An inner space is defined between the base 13 and the enclosure cover. Pressing process may be employed to form the enclosure cover out of a plate material, for example.

At least one magnetic recording disk 14 as a storage medium is enclosed in the enclosure 12. Here, three of the magnetic recording disks 14 are enclosed in the enclosure 12, for example. The magnetic recording disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rpm, or the like.

A carriage assembly 16 is also enclosed in the enclosure 12. The carriage assembly 16 includes a carriage 17. A carriage block 18 is incorporated in the carriage 17. The carriage block 18 includes a carriage block body 21 coupled to a vertical support shaft 19 for relative rotation. Four of parallel carriage arms 22, namely first to fourth carriage arms 22, project forward from the carriage block body 21, for example. The individual carriage arm 22 extends from the vertical support shaft 19 in the horizontal direction. The carriage block 18 may be made of aluminum, for example. Extrusion molding process may be employed to form the carriage block 18, for example.

A head suspension assembly 23 is attached to the front or tip end of the individual carriage arm 22. Two head suspension assemblies 23 are attached to the second and third carriage arms 22 between the upper and lower carriage arms 22. The individual head suspension assembly 23 includes a head suspension 24 extending forward from the front or tip ends of the carriage arm 22. A flexure is attached to the surface of the head suspension 24. The flexure will be described later in detail. A flying head slider 25 is supported on the flexure. A magnetic head or electromagnetic transducer is mounted on the flying head slider 25.

When the magnetic recording disk 14 rotates, the flying head slider 25 is allowed to receive airflow generated along the rotating magnetic recording disk 14. The airflow serves to generate a positive pressure or a lift as well as a negative pressure on the flying head slider 25. The lift is balanced with the urging force of the head suspension 24 and the negative pressure, so that the flying head slider 25 is allowed to keep flying above the surface of the magnetic recording disk 14 during the rotation of the magnetic recording disk 14 at a relatively high stability.

When the carriage 17 is driven to swing about the vertical support shaft 19 during the flight of the flying head slider 25, the flying head slider 25 is allowed to move in the radial direction of the magnetic recording disk 14. This radial movement allows the electromagnetic transducer on the flying head slider 25 to cross the data zone between the innermost recording track and the outermost recording track. The electromagnetic transducer on the flying head slider 25 can thus be positioned right above a target recording track on the magnetic recording disk 14.

A power source such as a voice coil motor, VCM, 26 is connected to the carriage block 18. The voice coil motor 26 serves to drive the carriage block 18 around the vertical support shaft 19. The rotation of the carriage block 18 allows the carriage arms 22 and the head suspensions 24 to swing.

As is apparent from FIG. 1, a flexible printed circuit board unit 27 is located on the carriage block 18. The flexible printed circuit board unit 27 includes a head IC (integrated circuit) 29 mounted on a flexible printed wiring board 28. The head IC 29 is designed to supply the read element of the electromagnetic transducer with a sensing current when the magnetic bit data is to be read. The head IC 29 is also designed to supply the write element of the electromagnetic transducer with a writing current when the magnetic bit data is to be written. A small-sized circuit board 31 is located within the inner space of the enclosure 12. A printed wiring board, not illustrated, is attached to the outward surface of the bottom plate of the base 13. The small-sized circuit board 31 and the printed wiring board on the bottom plate are designed to supply the head IC 29 with the sensing current and the writing current.

A flexure 32 is utilized to relay the sensing current and the writing current to the electromagnetic transducer. A wiring is formed in the flexure 32 as described later. One end of the flexure 32 is attached to the individual head suspension 24. The flexure 32 extends backward from the head suspension 24 along the side of the carriage arm 22. The other or rear end of the flexure 32 is overlaid on the flexible printed wiring board 28. The flexure 32 is connected to the flexible printed circuit board unit 27. The sensing current and the wiring current are supplied from the head IC 29 to the flying head slider 25 through the flexure 32. The head suspension assembly 23 has the so-called long-tail structure.

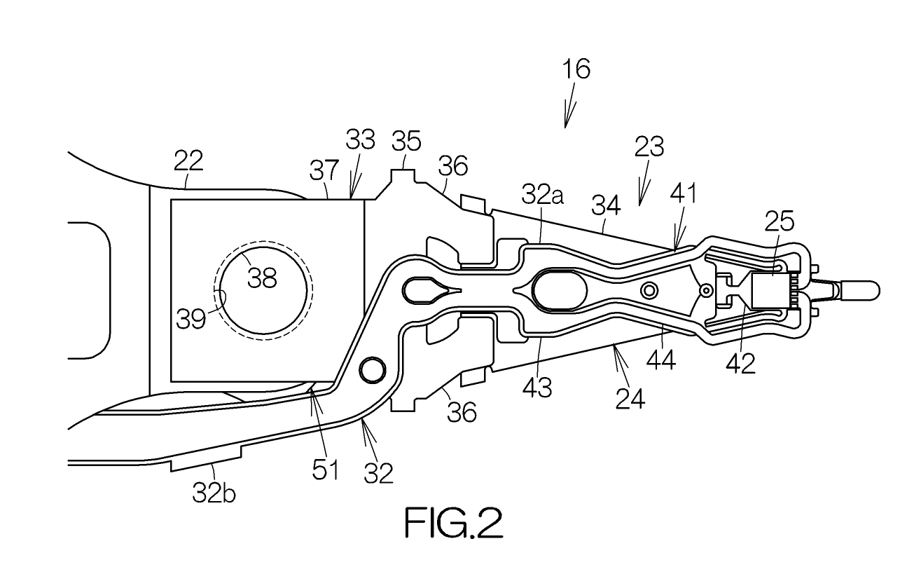

FIG. 2 schematically illustrates the carriage assembly 16 according to a first embodiment of the present invention. The head suspension 24 includes a base plate 33 and a load beam 34. The base plate 33 is attached to the tip end of the carriage arm 22. The load beam 34 is distanced forward from the base plate 33 at a predetermined interval. A hinge plate 35 is fixed to the surfaces of the base plate 33 and the load beam 34. The hinge plate 35 provides an elastic bending section 36 between the front end of the base plate 33 and the rear end of the load beam 34. The hinge plate 35 in this manner serves to couple the base plate 33 with the load beam 34. Each of the base plate 33, the load beam 34 and the hinge plate 35 is made out of a thin plate of stainless steel, for example.

The base plate 33 includes a base plate body 37 in the form of a plate. The base plate body 37 is received on the front surface of the carriage arm 22. The base plate body 37 includes a cylindrical boss 38 standing upright from the surface of the base plate body 37. The boss 38 is received in a cylindrical space, namely a caulking hole 39, defined in the tip end of the carriage arm 22. The longitudinal axis of the caulking hole 39 extends in parallel with the longitudinal axis of the vertical support shaft 19. The caulking hole 39 penetrates through the carriage arm 22 from the front surface to the back surface of the carriage arm 22. The boss 38 is urged against the inward wall surface of the caulking hole 39 based on so-called caulking. In this manner, the base plate 33, namely the head suspension assembly 23, is attached to the tip end of the carriage arm 22.

The aforementioned flexure 32 is attached to the surface of the head suspension 24. The flexure 32 includes a stainless steel plate 41. The stainless steel plate 41 includes a support plate 42 and a fixation plate 43. The flying head slider 25 is received on the surface of the support plate 42. The fixation plate 43 is partly fixed to the surfaces of the load beam 34 and the hinge plate 35. Spot welding may be effected at joint spots so as to fix the fixation plate 43, for example. The fixation plate 43 extends outward from the contour of the head suspension 24 along the side of the carriage arm 22. The support plate 42 and the fixation plate 43 are made out of a single thin plate of stainless steel. The flying head slider 25 is bonded to the surface of the support plate 42 through an adhesive. A wiring pattern 44 is formed on the surface of the fixation plate 43. One end of the wiring pattern 44 is connected to the flying head slider 25.

The wiring pattern 44 includes an insulating layer, six electrically-conductive patterns and a protection layer, overlaid on the stainless steel plate 41 in this sequence, for example. The six electrically-conductive patterns extend along lines parallel to one another. Four of the electrically-conductive patterns are utilized to supply the sensing current and the wiring current. The remain of the electrically-conductive patterns are utilized to supply electrical current to a heater incorporated in the flying head slider 25, for example. The heater is utilized for realization of the so-called Dynamic Flight Height (DFH). The electrically-conductive patterns are made of an electrically-conductive material such as copper. The insulating layer and the protection layer are made of a resin material such as polyimide resin.

The support plate 42 is received on a domed swelling, not illustrated, formed on the surface of the load beam 34 at a position behind the flying head slider 25. The aforementioned elastic bending section 36 is designed to exhibit elasticity or bending force of a predetermined intensity. The bending force is utilized to provide the front end of the load beam 34 with the aforementioned urging force toward the surface of the magnetic recording disk 14. The domed swelling behind the flying head slider 25 serves to apply the urging force to the flying head slider 25. The flying head slider 25 is designed to change its flying attitude based on a change in the lift generated based on airflow. The domed swelling allows a change in the attitude of the flying head slider 25, namely the support plate 42.

The flexure 32 defines a joint section 32a fixed to the surfaces of the load beam 34 and the hinge plate 35. The flexure 32 also defines a bridging section 32b continuous with the joint section 32a. The bridging section 32b is located outside the contour of the head suspension 24. The joint section 32a has one end located at the front or tip end of the load beam 34. The joint section 32a extends from its one end toward the tip end of the carriage arm 22. The other end of the joint section 32a is located at the side edge of the head suspension 24. One end of the bridging section 32b is connected to the other end of the joint section 32a at the side edge of the head suspension 24. In this manner, the head suspension assembly 23 has the so-called long-tail structure.

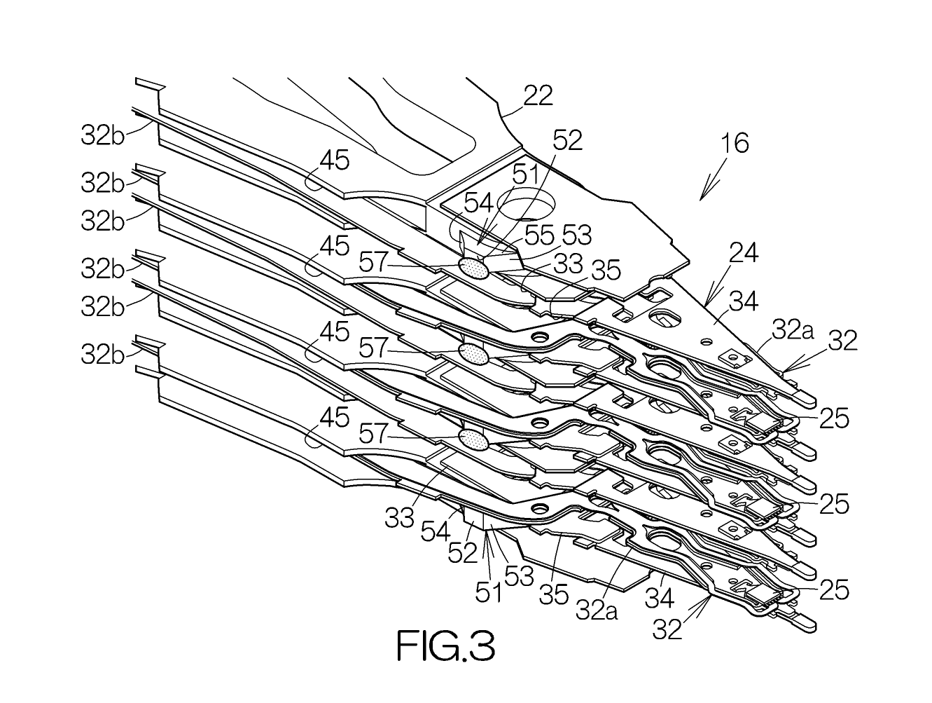

Referring also to FIG. 3, the bridging section 32b extends along the side of the carriage arm 22. The bridging section 32b is disposed in a groove 45 formed in the side of the carriage arm 22. The groove 45 extends in parallel with the front and back surfaces of the carriage arm 22. Each of the second and third carriage arms 22 defines the groove 45 receiving two of the protruding sections 32b. The other end of the bridging section 32b is located on the carriage block body 21. The other end of the wiring pattern 44 is connected to the head IC 29. In this manner, the flying head slider 25 is electrically connected to the head IC 29.

A projection 51 is formed on the side of the carriage arm 22 at the tip end of the carriage arm 22. The projection 51 protrudes from the side of the carriage arm 22 in the horizontal direction perpendicular to the vertical support shaft 19. Here, the projection 51 protrudes in the lateral direction of the carriage arm 22. The projection 51 is made of a metallic material such as aluminum. The projection 51 is formed integral with the carriage arm 22 based on molding, for example. Since the projection 51 is made of a relatively light metallic material such as aluminum, an increase in the weight of the carriage arm 22, namely the carriage 17, is suppressed to the utmost irrespective of formation of the projection 51.

The projection 51 includes a top surface 52 extending in parallel with the side of the carriage arm 22. A first inclined surface 53 is connected to the front edge of the top surface 52 on the projection 51. A second inclined surface 54 is connected to the rear edge of the top surface 52 on the protrusion 51. The first inclined surface 53 extends from the front edge of the top surface 52 toward the tip end of the carriage arm 22. The second inclined surface 54 extends from the rear edge of the top surface 52 toward the root end of the carriage arm 22. The first inclined surface 53 gets closer to the side of the carriage arm 22 as the position gets farther from the front edge of the top surface 52. Likewise, the second inclined surface 54 gets closer to the side of the carriage arm 22 as the position gets farther from the rear edge of the top surface 52.

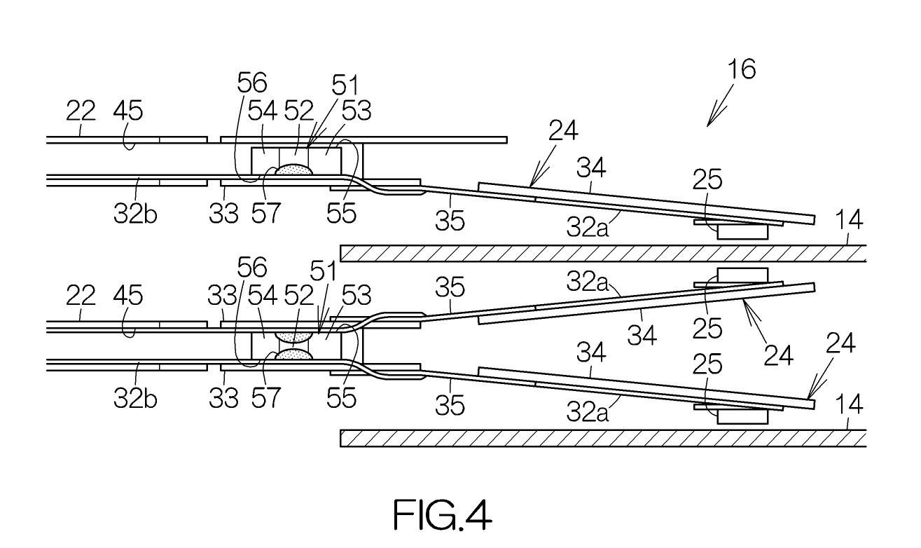

Referring also to FIG. 4, the projection 51 defines a first receiving surface 55 and a second receiving surface 56 extending in parallel with each other. The first receiving surface 55 and the second receiving surface 56 extend in parallel with the front and back surfaces of the carriage arm 22, for example. The first receiving surface 55 is a flattened surface extending at a level slightly lower than the front surface of the carriage arm 22. The second carriage arm 22 is a flattened surface extending at a level slightly lower than the back surface of the carriage arm 22. The thickness of the projection 51 is thus set smaller than that of the carriage arm 22. The thickness of the projection 51 and the carriage arm 22 are measured in the direction parallel to the vertical support shaft 19.

The back surface of the bridging section 32b of the flexure 32 is received on the first receiving surface 55 or the second receiving surface 56. An adhesive 57 is utilized to bond the bridging section 32b to the projection 51. A viscoelastic adhesive is employed as the adhesive 57, for example. The bridging section 32b is in this manner supported on the projection 51 at a position between the head suspension 24 and the groove 45. As is apparent from FIG. 4, a difference may be set equal to or larger than the thickness of the flexure 32 between the level of the first receiving surface 55 and the level of the opposed surface of the carriage arm 22 as well as between the level of the second receiving surface 56 and the level of the opposed surface of the carriage arm 22.

When the magnetic bit data is to be read, for example, a positioning signal is supplied to the voice coil motor 26 during the rotation of the magnetic recording disk 14, for example. The voice coil motor 26 drives the carriage block 18 around the vertical support shaft 19 in response to the positioning signal. The carriage arm 22 is opposed to the surface of the magnetic recording disk 14. The flying head slider 25 is positioned right above a predetermined recording track. The positioning signal is adjusted in accordance with the positional information read from the electromagnetic transducer. The so-called tracking servo control is executed. In this manner, the electromagnetic transducer is allowed to follow the recording track.

Airflow is generated along the surface of the rotating magnetic recording disk 14 during the flight of the flying head slider 25. The airflow collides against the carriage arm 22. The bridging section 32b of the flexure 32 is bonded to the projection 51 of the carriage arm 22 as described above. The bridging section 32b is thus prevented from fluttering outside the contour of the carriage arm 22. The bridging section 32b is thus significantly prevented from vibrating. Resonance of the carriage arm 22 is suppressed. The flying head slider 25 is positioned with a higher accuracy.

The inventors have observed the effect of the present invention. The inventors prepared the hard disk drive 11 according to a specific example of the invention and a hard disk drive according to a comparative example. The bridging section 32b of the flexure 32 was supported on the projection 51 in the specific example. The adhesive 57 was utilized to bond the bridging section 32b to the projection 51 in the specific example. No projection was formed on the side of the carriage arm in the comparative example. Positional information was read from the electromagnetic transducer on the flying head slider in the hard disk drive 11 according to the specific example and in the hard disk drive according to the comparative example. The so-called tracking servo control was executed in accordance with the positional information. The frequency characteristic of the vibration was analyzed based on the positioning signal.

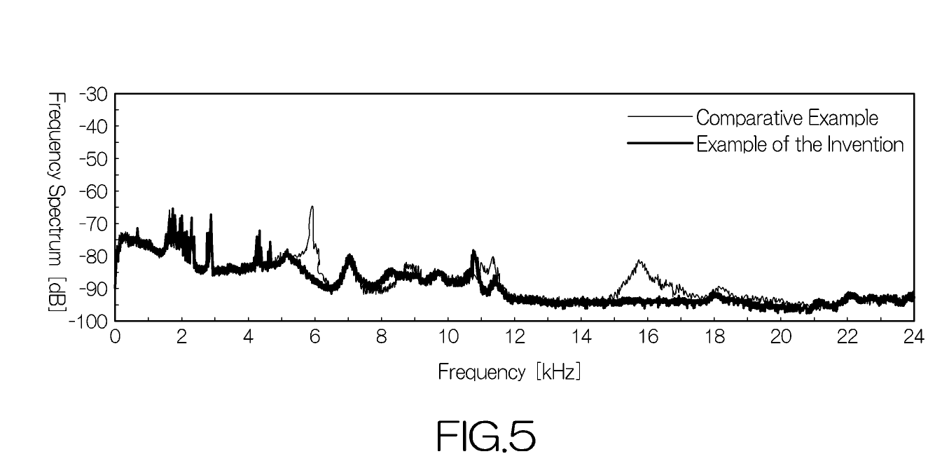

As illustrated in FIG. 5, it was demonstrated that the HDD 11 according to the specific example enjoys a reduction of vibration intensity over predetermined frequency ranges as compared with the HDD of the comparative example. In particular, a considerable reduction of vibration intensity was observed in a frequency range from 5,500 [Hz] to 6,500 [Hz] and in a frequency range from 15,000 [Hz] to 17,000 [Hz]. Such frequency ranges are understood as the vibrations of the bridging section 32b of the flexure 32. In other words, it has been demonstrated that the vibration in the bridging section 32b is significantly suppressed in the hard disk drive 11 according to the specific example because the bridging section 32b of the flexure 32 is bonded to the projection 51. It has also been demonstrated that the bridging section of the flexure vibrates in the hard disk drive according to the comparative example.

An extruded article having the contour of the carriage block 18 is first formed based on extrusion process in a method of making the carriage block 18, for example. The extruded article is made from a aluminum shape. The extruded article is then shaped into the carriage arm 22 based on scraping. A cutter is utilized for scraping, for example. The carriage block body 21 is in this manner formed. In this case, a projection having the same thickness as that of the carriage arm 22 is formed on the side of the carriage arm 22. The projection is shaped into the projection 51 based on scraping. The thickness of the projection 51 is set smaller than that of the carriage arm 22.

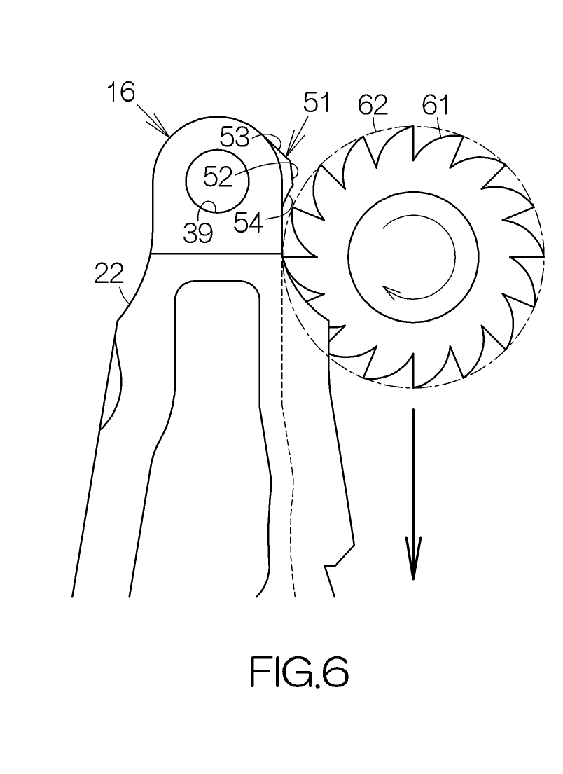

The side of the carriage arm 22 is scraped so as to provide the groove 45, as illustrated in FIG. 6. A cutter or chip saw 61 is utilized for scraping the carriage arm 22. The cutter 61, which is driven to rotate, is forced to contact the side of the carriage arm 22 in a range from the tip end of the carriage arm 22 to the root end of the carriage arm 22. The groove 45 is in this manner formed in the side of the carriage arm 22. The second inclined surface 54 is defined on the projection 51 as described above. The second inclined surface 54 gets closer to the side of the carriage arm 22 as the position gets farther from the top surface of the projection 51. The second inclined surface 54 is located outside the movement path of the contour 62 of the cutter 61. In this manner, the second inclined surface 54 serves to prevent the projection 51 from contacting with the cutter 61. The groove 45 can be formed in a relatively facilitated manner.

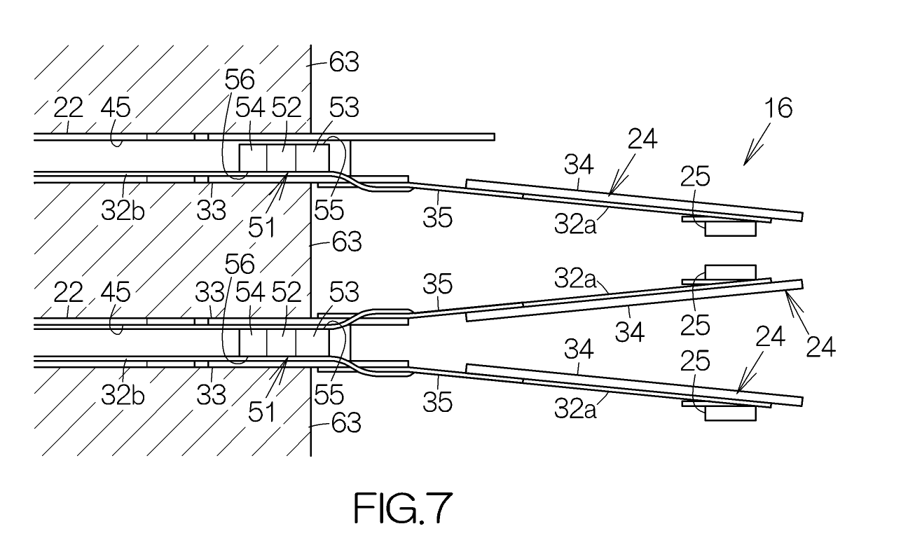

When the carriage block 18 has been made in the above-described manner, the head suspension assembly 23 is attached to the carriage block 18. The boss 38 of the base plate 33 is received in the caulking hole 39 of the carriage arm 22 for attachment of the head suspension assembly 23. As illustrated in FIG. 7, the individual carriage arms 22 are held between jigs 63. The individual jig 63 serves to urge the base plate 33 against the front or back surface of the carriage arm 22. A metallic ball for caulking, not illustrated, is then pushed into the caulking hole 39. As conventionally known, the boss 38 serves to attach the base plate 33, namely the head suspension assembly 23, to the tip end of the carriage arm 22 based on plastic deformation.

As is apparent from FIG. 7, the flattened surface of the individual jig 63 serves to urge the base plate 33 against the front or back surface of the carriage arm 22 during the process of attaching the base plate 33. The first receiving surface 55 and the second receiving surface 56 of the projection 51 are the flattened surfaces extending at the levels lower than the front and back surfaces of the carriage arm 22, respectively, as described above. The bridging section 32b is received on the first receiving surface 55 or the second receiving surface 56. Even though the jig 63 is urged against the carriage arm 22, the flattened surface of the jig 63 is reliably prevented from contacting the bridging section 32b. The flexure 32 is prevented from receiving damages at the bridging section 32b. The bridging section 32b extends at the level lower than the front or back surface of the carriage arm 22, the bridging section 32b can readily be inserted into the corresponding groove 45. The bridging section 32b of the flexure 32 is then bonded to the projection 51 with an adhesive.

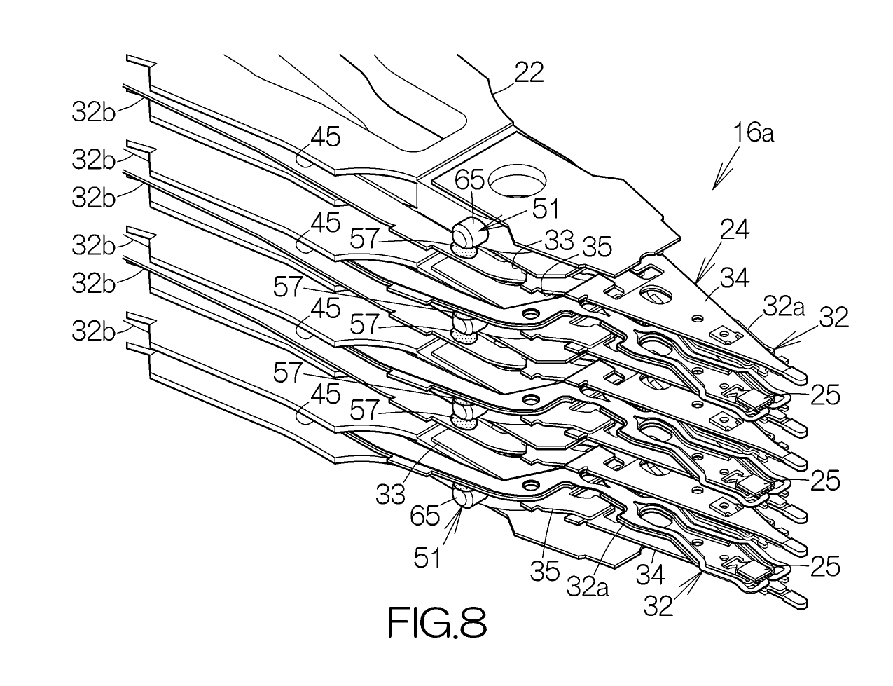

FIG. 8 schematically illustrates a carriage assembly 16a according to a second embodiment of the present invention. The carriage assembly 16a includes a columnar pin 65 in place of the above-described projection 51, for example. The pin 65 protrudes from the side of the carriage arm 22 in the lateral direction of the carriage arm 22. The longitudinal axis of the pin 65 is set perpendicular to an imaginary plane including the longitudinal center axis of the caulking hole 39, for example. The pin 65 is made of a metallic material such as aluminum in the same manner as the carriage arm 22. The bridging section 32b of the flexure 32 is received on the outer peripheral surface of the pin 65. The back surface of the bridging section 32b is bonded to the outer peripheral surface of the pin 65. The aforementioned adhesive 57 is utilized to bond the pin 65.

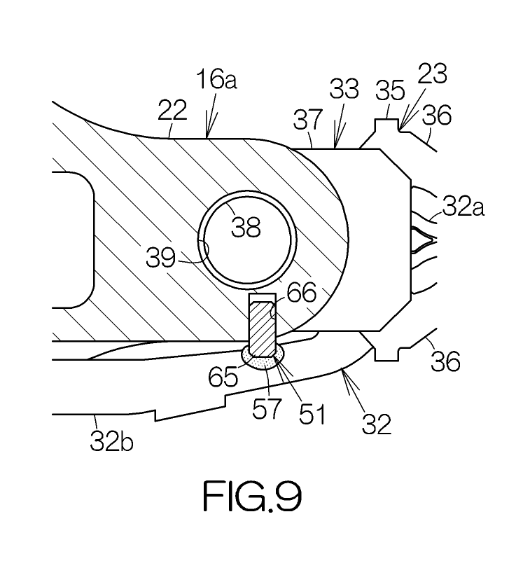

As illustrated in FIG. 9, the pin 65 is press-fitted into a receiving bore 66 formed in the side of the carriage arm 22. The diameter of the pin 65 is set smaller than the thickness of the carriage arm 22. The distance may be set equal to or larger than the thickness of the bridging section 32b between the front surface of the carriage arm 22 and the upper surface of the pin 65 as well as between the back surface of the carriage arm 22 and the lower surface of the pin 65. The flattened surface of the jig 63 is in this manner prevented from contacting the bridging section 32b even though the jig 63 is urged against the carriage arm 22 for attachment of the head suspension assembly 23 in the aforementioned manner. Like reference numerals are attached to the structure or components equivalent to those of the above-described carriage assembly 16. The carriage assembly 16a is allowed to enjoy advantages identical to the aforementioned ones.

All examples and conditional language recited herein are intended for pedagogical purposes to aid the reader in understanding the invention and concepts contributed by the inventor to furthering the art, and are to be construed as being without limitation to such specifically recited examples and conditions, nor does the organization of such examples in the specification relates to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A carriage assembly comprising:
a carriage block body coupled to a support shaft for relative rotation;
a carriage arm extending from the carriage block body along an imaginary plane perpendicular to a longitudinal axis of the support shaft;
a head suspension attached to a tip end of the carriage arm;
a wiring attached to a surface of the head suspension, the wiring extending backward outside a contour of the head suspension along a side of the carriage arm;
a projection protruding from the side of the carriage arm, the projection receiving the wiring; and
an adhesive utilized to bond the wiring to the projection.

2. The carriage assembly according to claim 1, wherein a thickness of the projection is set smaller than a thickness of the carriage arm, the thicknesses of the projection and the carriage arm being defined in a direction parallel to the support shaft.

3. The carriage assembly according to claim 1, wherein the projection is formed integral with the carriage arm.

4. The carriage assembly according to claim 1, wherein the projection is a pin received in a bore formed in the side of the carriage arm.

5. A disk drive comprising:
a disk medium;
a support shaft located at a position outside a contour of the disk medium;
a carriage block body coupled to the support shaft for relative rotation;
a carriage arm extending from the carriage block body along an imaginary plane perpendicular to a longitudinal axis of the support shaft;
a head suspension attached to a tip end of the carriage arm;
a wiring attached to a surface of the head suspension, the wiring extending backward outside a contour of the head suspension along a side of the carriage arm;
a projection protruding from the side of the carriage arm, the projection receiving the wiring; and
an adhesive utilized to bond the wiring to the projection.
